(19) United States
(12) Patent Application Publication
(10) Pub. No.: US 2020/0412030 A1
(43) Pub. Date: Dec. 31, 2020

(54) JUNCTION BOX ASSEMBLY AND TERMINAL ASSEMBLY CONFIGURED TO PREVENT A SHORT CIRCUIT

(71) Applicant: Sumitomo Wiring Systems, Ltd., Yokkaichi (JP)

(72) Inventors: Brian Carnick, Farmington Hills, MI (US); Bennie J. Malcom, Farmington Hills, MI (US)

(21) Appl. No.: 16/456,278

(22) Filed: Jun. 28, 2019

(51) Int. Cl. H01R 9/24; H01R 9/22; H01H 85/20

(52) U.S. Cl. CPC H01R 9/245; H01R 9/18; H01H 85/2045; H01R 9/223

(57) ABSTRACT

A junction box assembly and a terminal assembly configured to prevent a short circuit is provided. In one aspect, the terminal assembly includes a pair of terminals spaced apart from each other and a spacer configured to retain the pair of terminals in a fixed position with respect to each other. In another aspect, the spacer includes a plurality of fuses, and each fuse is electrically connected to a corresponding slot so as to help prevent a power surge through a respective output portion of the terminal. In yet another aspect, the terminal housing has a side wall having a rib extending a height at least as high as the combined height of the output portion and terminal connector when the two are laid on top of each other, preventing the terminal connector from coming into contact with an adjacent terminal connector.

### TECHNICAL FIELD

The present disclosure generally relates to a junction box assembly with a terminal assembly configured to prevent a short circuit. The terminal assembly may include a spacer configured to fix a pair of spaced apart terminals in a predetermined position. In one aspect, the spacer may include a plurality of fuses electrically coupled to a corresponding output portion of a terminal. In another aspect, the junction box may include a plurality of ribs configured to retain the plurality of output portions of the terminal in a fixed position relative to each other.

### BACKGROUND

Terminals are used in vehicles such as automotive vehicles to distribute electric power to electrical components. Automotive vehicles include a battery configured to provide electrical power. The battery may be used to provide power to electric components/systems of the automotive vehicle. Examples of electric components/systems include windshield wipers, turn signal devices, power side-view mirrors and a motor to drive the automotive vehicle. The junction box assembly distributes electrical power from the battery, or batteries, to the electric components. The junction box assembly includes a plurality of terminals configured to distribute the power from the battery to the electric components. The terminals are mounted to a bolt and includes an opening wider than the bolt so as to provide installation tolerance. However, the tolerance may be sufficient to allow the terminals to touch, creating a short circuit.

FIG. 1 depicts a conventional junction box assembly 200. The junction box assembly 200 includes a top housing 202 and a base 204. The base 204 may include a plurality of terminals 206 adjacent to each other. The base 204 may include a plurality of terminal connectors 208 attached to the terminals 206. The terminal connectors 208 may be secured to the terminals 206 by a plurality of bolts 210 and a nut (not shown).

The terminal connectors 208 may include an eyelet configured to receive the bolt 210. The bolt 210 may retain each terminal connector 208 onto each terminal 206 and in electrical contact with each terminal 206. However, due to vehicle movement for example, the terminal connectors 208 may rotate about the bolts. The rotation of the terminal connectors 208 may cause one of the terminal connectors 208 to touch another terminal connector 208 resulting in a short circuit. Additionally, a power surge from the battery may also result in a short circuit.

Accordingly, there remains a need to prevent a short circuit from occurring due to an unintended contact between the connector terminals. There is also a need to protect the electric components from a power surge.

### SUMMARY

A junction box assembly is provided. The junction box assembly includes a base having a terminal housing configured to house a terminal assembly. In one aspect, the terminal assembly includes a pair of terminals spaced apart from each other. Each of the terminals includes an input portion and an output portion. The output portion is generally orthogonal to the input portion. The terminal assembly may further include a spacer having a slot configured to receive an output portion of each of the spaced apart terminals. The slots may be configured to retain the pair of terminals in a fixed position with respect to each other.

In another embodiment, a terminal housing assembly may house a terminal assembly that includes a terminal having an input portion and a plurality of output portions formed as a unitary piece. The output portions are spaced apart from each other and electrically connected to the input portion. The terminal assembly includes a spacer. The spacer may include a plurality of slots configured to receive a respective output portion of the terminal. The spacer includes a plurality of fuses, and each fuse is electrically connected to a corresponding slot so as to help prevent a power surge through a respective output portion of the terminal.

In another embodiment, the junction box assembly includes a plurality of terminal housings. Each of the terminal housings includes a front wall, back wall and a pair of side walls so as to define a cavity for housing the output portion of the terminal and a corresponding terminal connector. The terminal housing further includes a pair of ribs disposed on a respective side wall of the terminal housing. Each of the ribs are spaced apart from each other so as to accommodate a width of a respective output portion of the terminal and the terminal connector. The ribs have a height which is taller than a height of the terminal connector and the output portion of the terminal when the two are laid on top of each other. Accordingly, the ribs prevent the terminal connectors from coming into contact with each other.

### BRIEF DESCRIPTION OF THE DRAWINGS

FIG. 1 depicts a junction box assembly of the prior art;

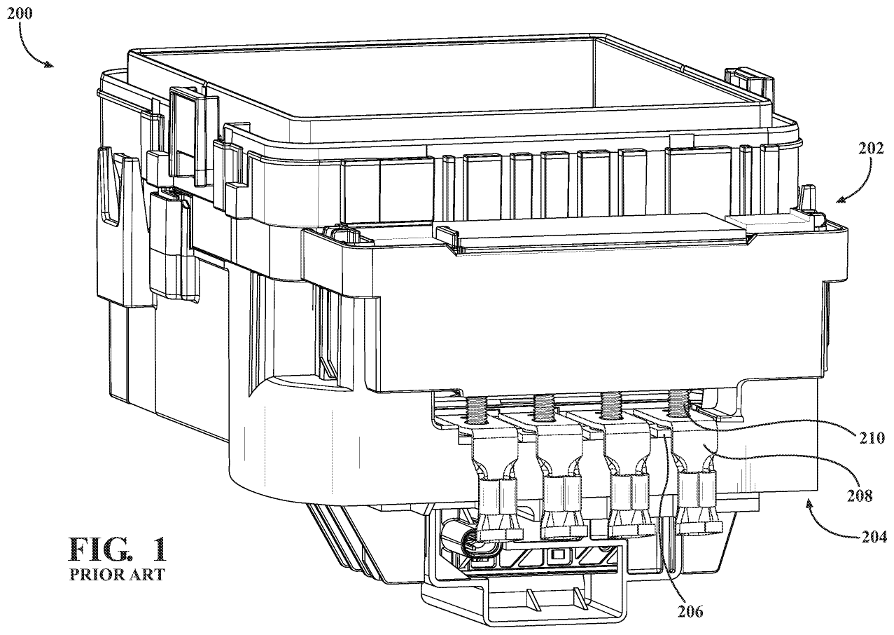

FIG. 2 is a perspective view of a junction box assembly according to one or more embodiments described herein;

FIG. 3 is a perspective view of a terminal assembly according to one or more embodiments described herein;

FIG. 4 is an exploded view of the terminal assembly shown in FIG. 3;

FIG. 5 is an isolated view of a base of a junction box assembly according to one or more embodiments described herein, the junction box assembly housing the housing the terminal assembly shown in FIG. 3;

FIG. 6 is a perspective view of another embodiment of a terminal assembly;

FIG. 7 is an exploded view of the terminal assembly shown in FIG. 6;

FIG. 8 is an isolated view of a base of a junction box assembly according to one or more embodiments described herein, the junction box assembly housing the housing the terminal assembly shown in FIG. 6;

FIG. 9 is a view of the base of a junction box assembly shown in FIGS. 5 and 8 with the terminal assembly removed; and

FIG. 10 is an exploded view of a junction box assembly according to one or more embodiments described herein.

### DETAILED DESCRIPTION OF PREFERRED EMBODIMENTS

Referring generally to the figures, embodiments of the present disclosure are directed to a junction box assembly and a terminal assembly configured to prevent a short circuit. In one aspect, the terminal assembly includes a pair of terminals and a spacer configured to fix the terminals in a fixed position relative to each other. In another aspect, the terminal assembly includes a spacer having a plurality of fuses configured to regulate voltage along the output portions of a terminal. In yet another aspect, the junction box assembly is configured to prevent terminal connectors from touching each other due to rotation.

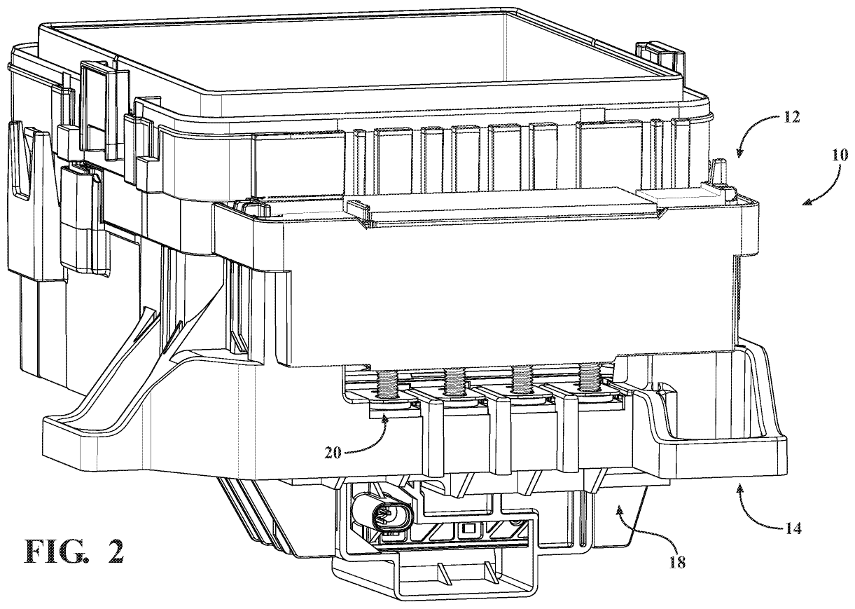

With reference now to FIG. 2, an illustrative embodiment of a junction box assembly 10 is provided. The junction box assembly 10 includes cover (not shown) configured to close a lower assembly 12. In one aspect of a lower assembly 12, the lower assembly 12 includes a top housing 14 and a base 16. However, it should be appreciated that the lower assembly 12 may be formed as a singular piece, in which case reference to a “base” as used in the claims may refer to the lower assembly. The top housing 14 may include electrical components configured to regulate and distribute power to various electric components/systems. The base 16 is configured to receive power from a power source (not shown) such as a battery or batteries. The base 16 includes a terminal housing assembly 18. The terminal housing assembly 18 is configured to house a terminal assembly 20.

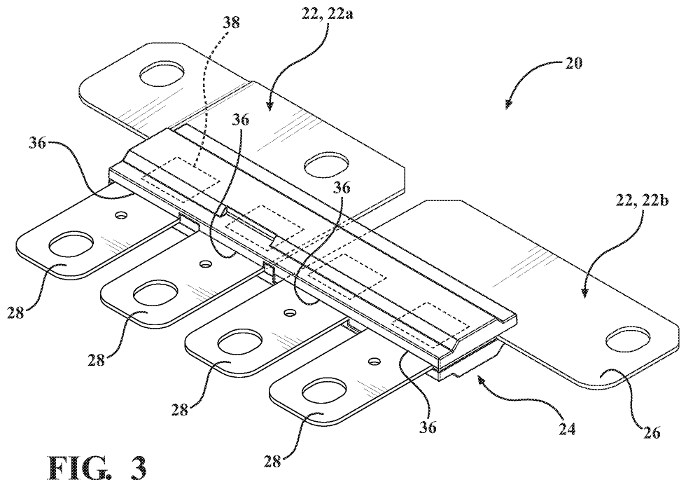

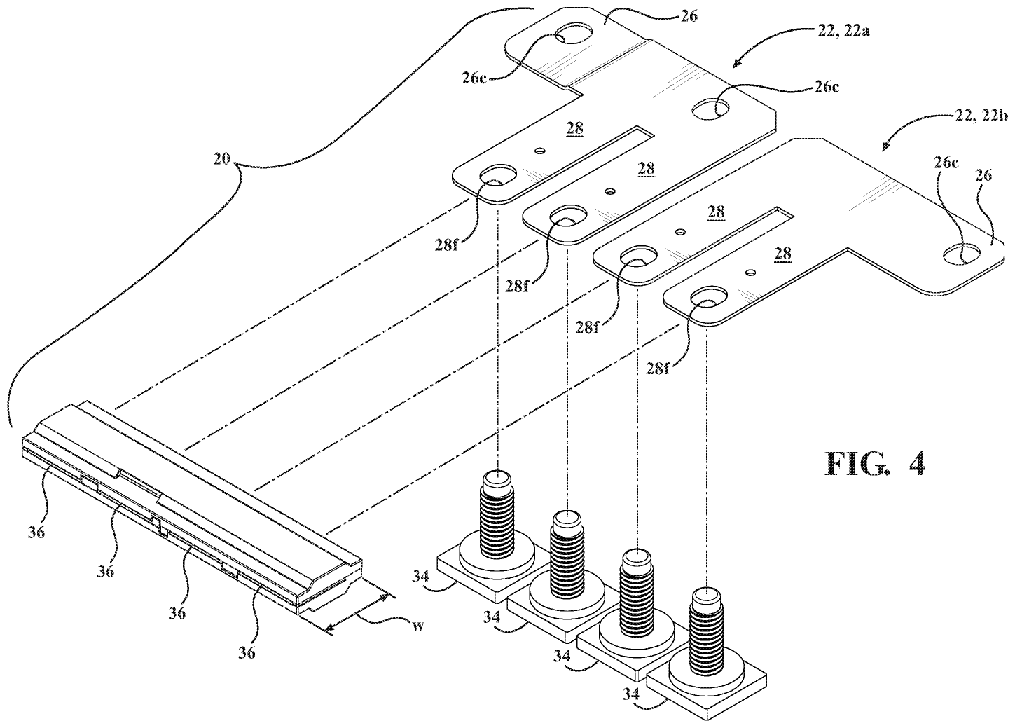

With reference now to FIGS. 3 and 4, an illustrative depiction of a terminal assembly 20 in accordance with a first embodiment is provided. The terminal assembly 20 includes a terminal 22 and a spacer 24. The terminal 22 includes an input portion 26 and an output portion 28. Terminal connectors 30 may be attached to the output portion 28 of a respective terminal 22 through the use of a conventional nut 32 which is screwed onto a bolt 34.

The terminal 22 includes a first terminal 22a and a second terminal 22b that are spaced apart from each other. The input portions 26 and output portions 28 of the first and second terminals 22a, 22b are shown as being similar to each other in shape and dimension. However, it should be appreciated that the shape and dimension of the input portions 26 and output portions 28 may differ from each other based upon packaging constraints or technical demands. For instance, it may be desirable to have a particular input or output portion 26, 28 have a smaller length or dimension than what is shown so as to reduce the resistance of the terminal 22.

Each of the pair of terminals 22a, 22b are generally planar members may include one input portion 26 and at least a pair of output portions 28. The pair of output portions 28 may be generally orthogonal to the input portion 26. Each pair of terminals 22a, 22b are fixedly coupled to the spacer 24 so as to be spaced apart from each other in a fixed manner.

The spacer 24 is formed of a non-conductive material and includes a plurality of slots 36 configured to accept each of the output portions 28 of the pair of terminals. Non-conductive material which may be used to form the spacer 24 includes, but is not limited to a plastic based material such as polypropylene configured to meet flammability standards for horizontal burn and/or vertical burn (HB or VO) such as materials commonly known as Polylac PA-765, Vectra E130i, Maxxam FR PP 301 and the like. The spacer 24 may be an elongated member. The slots 36 are shown as being generally equally spaced apart from each other. The slots 36 define an open first end and second end of the spacer 24 and extend along an axis defined by the width “W” of the spacer 24.

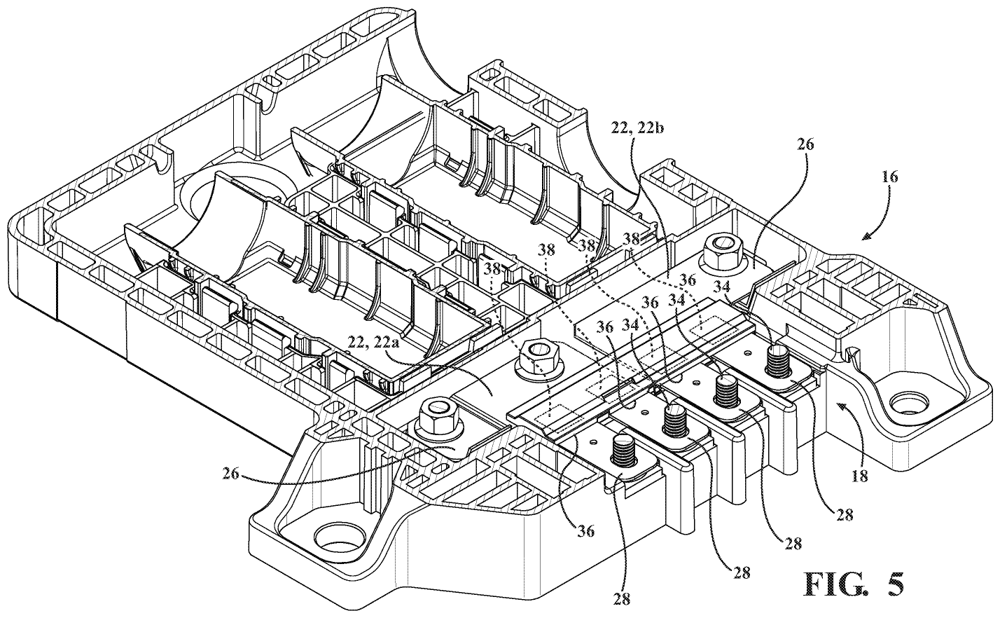

FIGS. 3-5 show an embodiment of the terminal assembly 20 wherein the terminals 22a, 22b each have a pair of output portions 28 and the spacer 24 includes four slots 36 configured to receive each of the output portions 28. FIG. 5 shows the terminal assembly 20 mounted within the base 16. The input portions 26 may be electrically coupled to a power source (not shown). In one aspect, the power source is a first battery having a first voltage, and a second battery having a second voltage which is different than the first voltage. For illustrative purposes, we assume that the input portion 26 of the first terminal 22a is electrically connected to the first battery and the input portion 26 of the second terminal 22b is electrically connected to the second battery. Each of the output portions 28 includes an opening 28f for receiving a respective bolt 34. Likewise, the input portions 26 have openings 26c and are mounted to the terminal housing assembly with bolts 34. As the openings 26c and 28f are wider in diameter than the bolts 34, the first terminal 22a may rotate as a unit relative to the second terminal 22b. As such, the spacer 24 retains the first terminal 22a in a fixed position with the second terminal 22b which prevents the terminals 22a, 22b from touching and creating a short circuit.

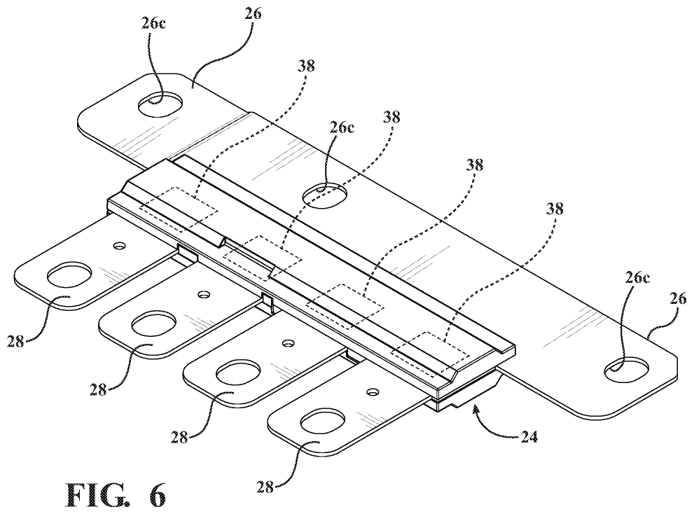

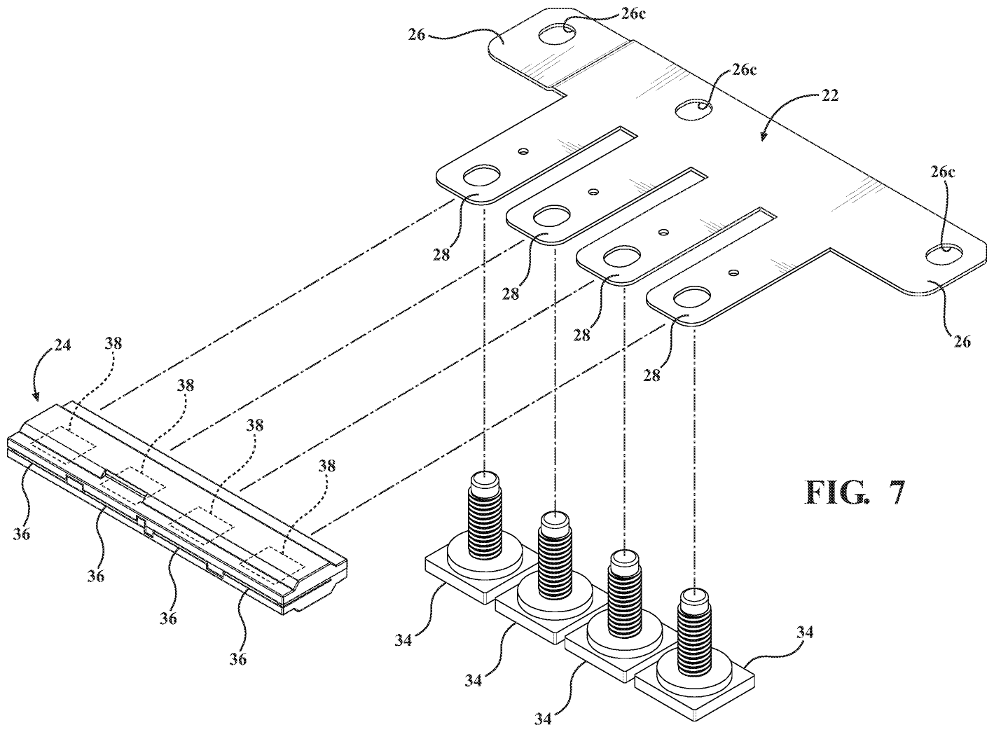

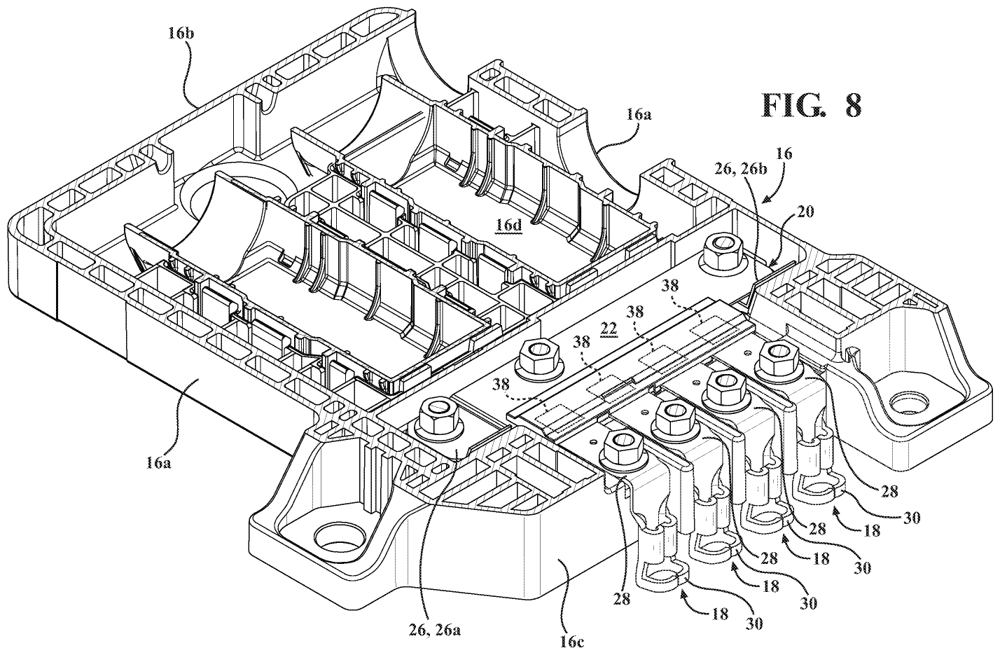

With reference now to FIGS. 6-8, another aspect of the terminal assembly 20 is provided. The terminal assembly 20 includes a terminal 22 and a spacer 24. The terminal 22 is formed as a unitary member. The input portions 26 are formed on opposite ends of the terminal 22. Each input portion 26 includes openings 26c to allow for the terminal 22 to be fixed to the base 16. The terminal 22 is shown as having four output portions 28, each having an opening 28f configured to receive a bolt 34.

The spacer 24 is formed of a non-conductive material and includes a plurality of slots 36 configured to accept each of the output portions 28 of the pair of terminals. The spacer 24 may be an elongated member. The slots 36 are shown as being generally equally spaced apart from each other. The slots 36 define an open first end and second end of the spacer 24 and extend along an axis defined by the width “W” of the spacer 24.

In one aspect, the spacer 24 may include a plurality of fuses 38. Each fuse 38 is configured to prevent a power surge along a corresponding output portion 28. In a preferred embodiment, the fuses 38 are integrally formed to the spacer 24. As such, it may be that the fuses 38 have the same resistance or may have different resistances based upon the desired property of the output portion 28. The fuses 38 are disposed on the spacer 24 so as to be open to the slots 36. As such, each fuse 38 is in electric communication with a corresponding output portion 28 disposed in a respective slot 36.

With reference again to FIG. 3, yet another aspect of an embodiment is provided wherein the terminal 22 includes a first terminal 22a and a second terminal 22b that are spaced apart from each other. Each of the pair of terminals 22a, 22b are generally planar members may include one input portion 26 and at least a pair of output portions 28. The pair of output portions 28 may be generally orthogonal to the input portion 26. Each pair of terminals 22a, 22b are fixedly coupled to the spacer 24 so as to be spaced apart from each other in a fixed manner. The spacer 24 include a plurality of fuses 38. Each fuse 38 is configured to prevent a power surge along a corresponding output portion 28. As such, the terminal assembly 20 is configured to both fix the pair of spaced apart terminals 22a, 22b with respect to each other as well as prevent a power surge through each of the respective output portions 28.

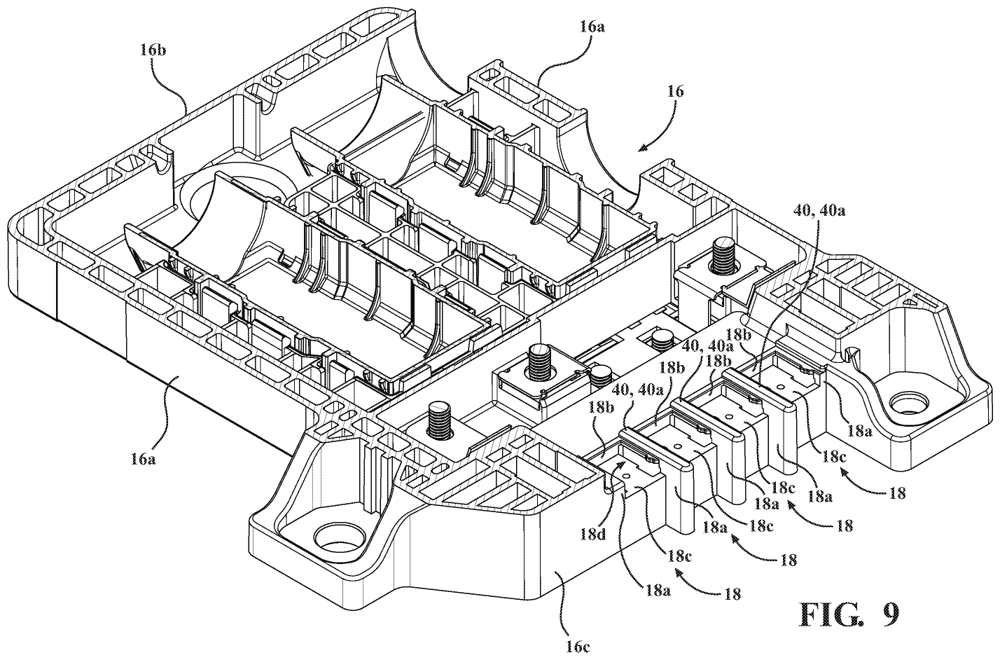

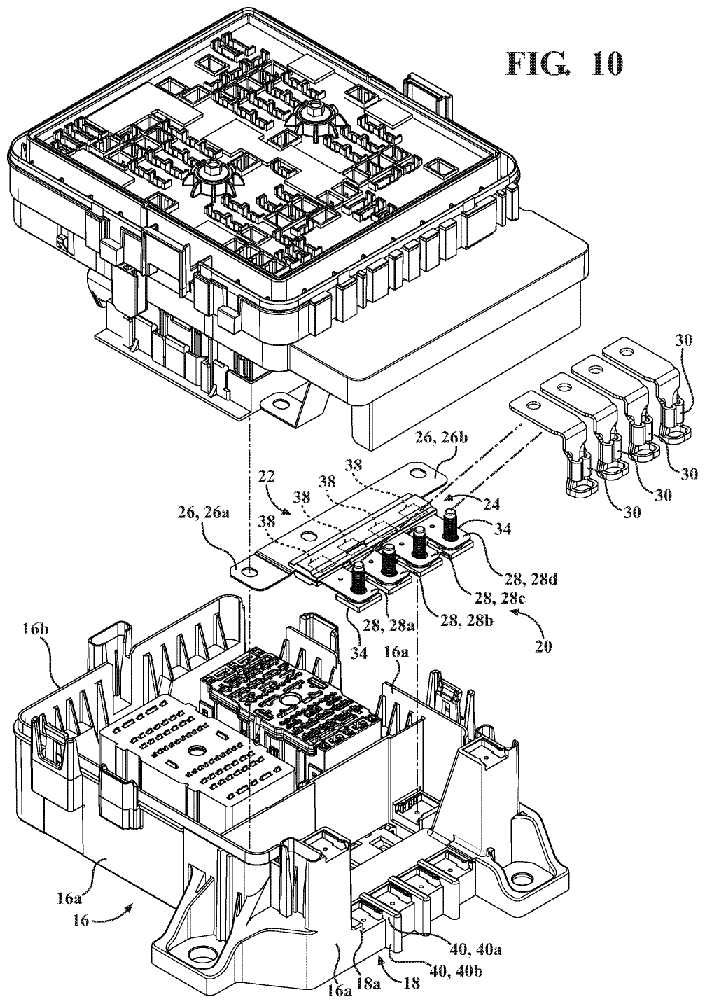

With reference now to FIGS. 9-10 an embodiment of a junction box assembly 10 is provided. The junction box assembly 10 is configured to prevent a short circuit from occurring by preventing terminal connectors 30 from touching each other. FIG. 9 provides an isolated view of the base 16. The base 16 includes a pair of side walls 16a, a back wall 16b, a front wall 16c mounted to a floor 16d so as to define a storage space 16f The terminal housing assembly 18 is shown illustratively disposed on the front wall 16c of the base 16. However, it should be appreciated that the terminal housing assembly may be disposed on any of the walls, 16a-16c without deviating from the scope of the appended claims.

The base 16 illustratively shows an embodiment wherein four (4) terminal housings 18 are provided. Each terminal housing 18 is configured to house a terminal assembly 20 and a terminal connector 30. The terminal connectors 30 are laid on top of a respective output portion 28 of the terminal 22 and secured thereto by a threaded engagement of a nut onto the bolt 34.

The terminal housing 18 includes a pair of side walls 18a, a back wall 18b and a floor 18c so as to define a cavity 18d having an open top and an open front. The side walls 18a include a rib 40 disposed on a top edge of the side wall 18a. The rib 40 extends a height at least as high as the combined height of the output portion 28 and terminal connector 30 when the two are laid on top of each other. Thus, rotation of the terminal connector 30 is limited by engagement of the terminal connector 30 with the rib 40. In one aspect, the rib 40 includes a top portion 40a and a bottom portion 40b, wherein the top portion 40a is disposed on the side wall 18a of the terminal housing 18 and the bottom portion 40b is disposed on a front wall 16c of the base 16.

The junction box may be configured to accept power from two different power sources. For example, the junction box may be configured to accept power from a first battery (omitted from view) and a second battery (omitted from view). The first battery may be a 12V battery, and the second battery may be a 48V battery. The first battery may be electrically connected to a first input portion 26a of the terminal 22, and the second battery may be electrically connected to a second input portion 26b of the terminal 22. The first input portion 26a may be configured to conduct power to the output portions 28a and 28b, while input portion 26b conducts power to output portions 28c, 28d. The spacer 24 may include a plurality of fuses 38. The fuses 38 may have different resistances, or may have the same resistance based upon engineering requirements.

It should be appreciated that the base 16 may be configured to house an embodiment of a terminal assembly 20 wherein the terminal 22 includes a first terminal 22 and a second terminal 22b. In such an embodiment, the spacer 24 is configured to fix the first and second terminals 22a, 22b with respect to each other and the ribs 40 are configured to prevent the terminal connectors 30 from touching each other. In such an aspect, the spacer 24 may also include fuses 38 configured to prevent a power surge.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1.-4. (canceled)

5. A terminal assembly comprising:
a terminal including an input portion and a plurality of output portions, wherein each of the plurality of output portions are spaced apart from each other and are electrically connected to the input portion; and
a spacer having a plurality of slots configured to receive a respective output portion of the plurality of output portions, wherein the spacer includes a plurality of fuses electrically, each of the fuses being integrally formed to the spacer and has a contact surface which is open to the slots, the contact surface contacting the output portion of a respective terminal so as to regulate power through each of the output portions of the terminal.

6. The terminal assembly of claim 5, wherein each fuse of the plurality of fuses has a different resistance than each other.

7. The terminal assembly of claim 5, wherein each fuse of the plurality of fuses has a same resistance as each other fuse of the plurality of fuses.

8. The terminal assembly of claim 5, wherein the terminal assembly includes a pair of terminals, each of the pair of terminals being spaced apart from each other.

9. A junction box assembly configured to receive at least a pair of terminal connectors, the junction box assembly comprising:
a terminal assembly having a terminal, the terminal having an input portion and a pair of output portions;
a pair of terminal connectors configured to be mounted on top of a corresponding one of the pair of output portions; and
a base having at least a pair of terminal housings, each of the pair of terminal housings includes a back wall, a front wall and a pair of side walls so as to define a cavity for housing a respective output portion of the terminal, the pair of terminal connectors completely seated within the at least pair of terminal housings, the at least one pair of terminal housings further configured to house a corresponding terminal connector of the pair of terminal connectors wherein a portion of each of the pair of terminal connectors faces the front wall of the base, the pair of side walls are spaced apart from each other so as to accommodate a width of a respective pair of output portions of the terminal and each of the pair of terminal connectors wherein the terminal housing further includes a rib disposed on a respective side wall separating the pair of side walls of the terminal housing, the rib has a height at least as tall as a height of one of the pair of the terminal connectors laid on top of and one of the pair of output portions of the terminal so as to prevent the pair of terminal connectors from contacting each other.

10. The junction box assembly of claim 9, wherein the rib includes a top portion and a bottom portion, the top portion is disposed on the respective side wall and the bottom portion extends beyond the front wall of the base.

11. The junction box assembly of claim 9, wherein the terminal assembly comprises:
a pair of terminals spaced apart from each other, each of the pair of terminals having an input portion and an output portion; and
a spacer having a plurality of slots configured to receive a respective output portion so as to retain the output portions in a fixed position with respect to each other.

12. The junction box assembly of claim 11, wherein the spacer is made of a non-conductive material includes a number of fuses corresponding to a number of the plurality of slots.
